(19) United States
(12) Patent Application Publication
(10) Pub. No.: US 2025/0211544 A1
(43) Pub. Date: Jun. 26, 2025

(54) METHOD AND APPARATUS FOR TRANSMITTING PACKET

(71) Applicant: CLOUD INTELLIGENCE ASSETS HOLDING (SINGAPORE) PRIVATE LIMITED, Singapore (SG)

(72) Inventor: Chen LIANG, Beijing (CN)

(21) Appl. No.: 18/852,372

(22) PCT Filed: Mar. 30, 2023
(86) PCT No.: PCT/CN2023/085243

§ 371 Date: Sep. 27, 2024

(30) Foreign Application Priority Data
Apr. 1, 2022 (CN) 202210349326.X

(51) Int. Cl. H04L 47/52; H04L 47/25; H04L 49/00

(52) U.S. Cl. CPC H04L 47/52; H04L 47/25; H04L 49/30

(57) ABSTRACT

Embodiments of the present application provide a method and an apparatus for transmitting a packet. The method includes: determining, from a plurality of physical ports of a physical network interface card, a target port whose load condition meets a preset condition; determining a target queue corresponding to the target port based on mapping relationships between the plurality of physical ports and a plurality of queues, where one or more queues of the plurality of queues correspond to one physical port of the plurality of physical ports, and the plurality of queues are used to cache to-be-transmitted packets; and transmitting a packet in the target queue through the target port. Through excluding a heavy loaded physical port and determining a queue corresponding to a light loaded physical port, and then transmitting a packet taken from the queue corresponding to the light loaded physical port through the light loaded physical port, load balance of the physical ports is achieved.

### CROSS-REFERENCE TO RELATED APPLICATIONS

This application is a National Stage of International Application No. PCT/CN2023/085243, and filed on Mar. 30, 2023, which claims priority to Chinese patent application No. 202210349326.X, entitled “METHOD AND APPARATUS FOR TRANSMITTING PACKET” and filed to the China National Intellectual Property Administration on Apr. 1, 2022. The disclosures of the aforementioned applications are hereby incorporated by reference in their entireties.

### TECHNICAL FIELD

The present application relates to the field of computers and, in particular, to a method and an apparatus for transmitting a packet.

### BACKGROUND

With the continuous development of computer technologies, more and more users use virtual network interface cards in virtual machines (VM) to transmit packets. When transmitting a packet, the virtual network interface card takes a packet from a queue for temporarily storing packets in a memory of the virtual machine, and transmits the packet to the physical network interface card. The packet reaches a physical network through one of multiple physical ports of the physical network interface card.

At present, after taking a packet from the queue, the virtual network interface card places the taken packet in a cache area of the virtual network interface card, calculates a hash value through the five-tuple carried by the packet, and determines which physical port of the physical network interface card the packet is sent from according to the hash value. However, since the virtual network interface card blindly accesses the packets in the queues, the packet may be sent to a heavy-loaded physical port, causing increasing of the delay of the heavy-loaded physical port and traffic congestion; while a light-loaded physical port may not have reached the bandwidth limit, resulting in an unbalanced load of the physical ports.

Therefore, how to achieve load balance of physical ports has become a technical problem to be solved urgently.

### SUMMARY

The present application provides a method and an apparatus for transmitting a packet, to achieve load balance of physical ports.

In a first aspect, the present application provides a method for transmitting a packet. The method including: determining, from a plurality of physical ports of a physical network interface card, a target port whose load condition meets a preset condition; determining a target queue corresponding to the target port based on mapping relationships between the plurality of physical ports and a plurality of queues, where one or more queues of the plurality of queues correspond to one physical port of the plurality of physical ports, and the plurality of queues are used to cache to-be-transmitted packets; and transmitting a packet in the target queue through the target port.

Based on the above scheme, when the virtual network interface card needs to transmit a packet, the following can be performed: excluding a heavy-loaded physical port from the plurality of physical ports according to load conditions of the ports of the physical network interface card and the preset condition, determining the light-loaded physical port as the target port, and determining the target queue corresponding to the target port according to the mapping relationships between the plurality of physical ports and the plurality of queues, and taking the packet from the target queue and transmitting the packet through the target port. Since the light-loaded physical port is determined first, and there is a mapping relationship between the physical port and the queue, based on the determined light-loaded physical port, the virtual network interface card can take the packet from the corresponding queue for transmission. On the one hand, the traffic of the light-loaded physical port can be increased, and its transmission rate can be improved to reach the bandwidth limit. On the other hand, the transmission of packets through the heavy-loaded physical port can be temporarily postponed to avoid further aggravation of transmission delay and congestion. Therefore, the bandwidth of each physical port can reach an upper limit, the transmission delay and congestion are alleviated, and the load balance between the physical ports is achieved.

In an implementation, the preset condition includes: a number of accumulated packets is less than a preset threshold.

In an implementation, the preset condition includes: a rate at which packets enter a physical port is higher than a rate at which packets are sent from the physical port per unit time.

In an implementation, the method further includes: obtaining the mapping relationships between the plurality of physical ports and the plurality of queues.

In an implementation, the method further includes: adjusting the mapping relationships between the plurality of physical ports and the plurality of queues according to a number of packets in each of the plurality of queues.

In a second aspect, the present application provides an apparatus for transmitting a packet, including modules or units for implementing the method in the first aspect and any possible implementation of the first aspect. It should be understood that each of the modules or units can implement the corresponding function by executing a computer program.

In a third aspect, the present application provides an apparatus for transmitting a packet. The apparatus includes a processor coupled to a memory, and the processor can be used to execute a computer program in the memory to implement the method in the first aspect and any possible implementation of the first aspect.

In an implementation, the apparatus for transmitting the packet may further include a memory for storing computer-readable instructions, and the processor reads the computer-readable instructions, so that the apparatus for transmitting the packet can implement the method in the first aspect and any possible implementation of the first aspect.

In an implementation, the apparatus for transmitting a packet may further include a communication interface which is used for the apparatus to communicate with other devices. For example, the communication interface may be a transceiver, a circuit, a bus, a module or other type of communication interfaces.

In a fourth aspect, the present application provides a chip system, which includes at least one processor used to support the implementation of functions involved in the first aspect and any possible implementation of the first aspect, such as processing the determination of the target port and target queue involved in the above method.

In a possible design, the chip system further includes a memory which is used to store program instructions and data, and the memory is located inside or outside the processor.

The chip system may be composed of a chip, or may include a chip and other discrete devices.

In a fifth aspect, the present application provides an electronic device, which includes: a processor, a memory, and a computer program stored in the memory and executable in the processor, and when the computer program is executed by the processor, the method in the first aspect and any possible implementation of the first aspect is implemented.

In a sixth aspect, the present application provides a computer-readable storage medium, which stores a computer program, and when the computer program is executed by the processor, the processor is caused to implement the method in the first aspect and any possible implementation of the first aspect.

It should be understood that technical solutions of the second to sixth aspects of the present application correspond to the technical solutions of the first aspect of the present application, and beneficial effects achieved by the various aspects and the corresponding feasible implementations are similar, which will not be repeated.

### BRIEF DESCRIPTION OF DRAWINGS

FIG. 1 is a schematic diagram of a network architecture provided by an embodiment of the present application.

FIG. 2 is a schematic flow chart of a method for transmitting a packet provided by an embodiment of the present application.

FIG. 3 is a schematic block diagram of an apparatus for transmitting a packet provided by an embodiment of the present application.

FIG. 4 is another schematic block diagram of an apparatus for transmitting a packet provided by an embodiment of the present application.

### DESCRIPTION OF EMBODIMENTS

Technical solutions of the present application will be described below in conjunction with accompanying drawings.

To facilitate understanding of embodiments of the present application, relevant terms involved in the present application are briefly explained below.

1. A Virtual machine refers to a complete computer system running in a completely isolated environment with complete hardware system functions implemented through software simulation. Any work that can be completed in a physical computer can be achieved in the virtual machine. The virtual machines enable each cloud computing user to believe that he/she has an independent hardware environment. One or more virtual machines can be built in a cloud server. Different operating systems and application layer software can be installed in respective virtual machines based on different user requirements.

2. A virtual switch is widely used in Internet services which are based on infrastructure as a service. Through the virtual switch running in the virtualization platform, the virtual machine built in the server is provided with Layer 2 network access and some Layer 3 network functions. The virtual machine is connected to the network through the virtual switch, and the virtual switch acts as a connection between uplink and the external network through the physical network interface card in the physical host. Each virtual switch contains a certain number of ports that can be used to connect to the virtual network interface card or the physical network interface card.

3. A virtual machine monitor (hypervisor) is a software layer installed in the physical hardware and can divide the physical machine into many virtual machines through virtualization. In this way, multiple operating systems can run simultaneously in one physical hardware. The hypervisor may be responsible for managing and allocating system resources to the virtual machines.

4. A physical network interface card, commonly known as a network interface card, is a piece of computer hardware designed to allow computers to perform communication in a computer network. The network interface card is a network component working at the physical layer and is an interface that connects computers and transmission media in a local area network. The network interface card can not only realize a physical connection and electrical signal matching with the local area network transmission media, but also involves transmission and reception of frames, encapsulation and de-encapsulation of frames, media access control, data encoding and decoding, and data caching functions. The network interface card is equipped with a processor (central processing unit, CPU) and a memory, and the memory includes a read only memory (ROM) and a random access memory (RAM). Communication between the network interface card and the local area network is carried out in a serial transmission mode through a cable or twisted pair, while communication between the network interface card and the computer is carried out in a parallel transmission mode through an I/O bus on the computer motherboard. Therefore, an important function of the network interface card is to perform serial/parallel conversion. Since the data rate in the network is different from the data rate in the computer bus, a storage chip for caching data is installed in the network interface card. A physical network interface card can include multiple physical ports, and transmission and reception of packets are realized through the physical ports.

It should be understood that data rate generally refers to data transfer rate, which refers to the speed of transmitting information in the communication line, i.e., the number of bits transmitted in a unit of time (usually one second). Each physical network interface card may include at least one physical port, and a packet can be sent to the physical network via the physical port.

5. Virtual network interface card, also known as a virtual network adapter, that is, using software to simulate the network environment and simulate the network adapter. The virtual network interface card can establish a local area network between remote computers, simulate a hub function, and realize functions of a virtual private network (VPN), so that the system recognizes the software as a network interface card. Like the physical network interface card, the virtual network interface card may include a cache area, which can be used to cache data. For example, in an embodiment of the present application, the cache area can be used to cache mapping relationships between multiple physical ports and multiple queues, as well as the packet obtained from the queue and about to be sent to the physical port. The virtual network interface card exposes a virtual network interface card interface to the virtual machine.

The functions of the virtual network interface card can be implemented by software, hardware, or a combination of software and hardware. The functions of the virtual network interface card in embodiments of the present application can be implemented by a physical network interface card which can be a board card (such as a printed circuit board (PCB)) inserted into a physical device. The board card includes a chip, and the chip can implement the method described in the following embodiments by executing a computer program or by a logic circuit or an integrated circuit solidified on the chip.

6. A queue is used to temporarily store packets for communication between the host and the network interface card. In embodiments of the present application, the queue can refer to an area in the memory of the virtual machine, which is used to temporarily store packets for communication between the virtual machine and the virtual network interface card, for example, including packets sent by application layer software, and/or, packets received by the physical network from other devices. Based on different transmitting directions, the queue can also be divided into a transmitting queue and a receiving queue. Multiple queues can be created for the memory of each virtual machine, and different queues can be distinguished by different identifiers.

It should be understood that the queue can be regarded as a communication interface between the application layer software and the virtual network interface card, and access of packets can follow a principle of first in first out (FIFO).

7. A physical switch is a network device used for forwarding electrical (optical) signals, can provide an exclusive electrical signal path for any two network nodes connected to the switch, and can transmit the packet sent by the physical network interface card to the physical network.

8. A physical network is a network formed by connecting various physical devices (such as hosts, routers, switches, etc.) and media (such as optical cables, cables, twisted pairs, etc.) in the network. The physical network is an underlying network carried by the Internet and is the first layer in the seven-layer architecture of the reference model for open system interconnection (OSI). It should be understood that OSI provides a framework of functional structure for open interconnected information systems. Layers of the OSI from low to high are: a physical layer, a data link layer, a network layer, a transport layer, a session layer, a presentation layer and an application layer.

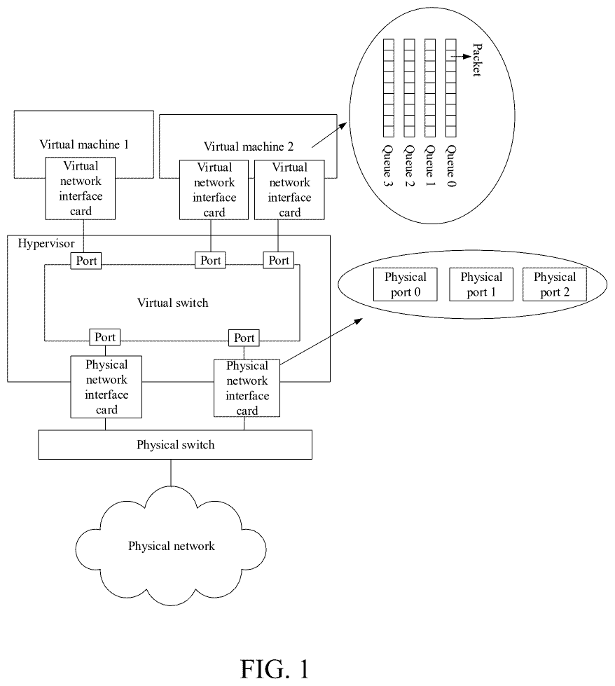

FIG. 1 is a schematic diagram of a network architecture applicable to an embodiment of the present application. As shown in FIG. 1, the network architecture may include: a virtual machine, a virtual switch and a physical switch. The virtual machine and the virtual switch are connected through a virtual network interface card in the virtual machine and a port in the virtual switch, and the virtual switch and the physical switch are connected through a physical network interface card.

One or more virtual machines are built in a server. As shown in FIG. 1, the virtual machine 1 and the virtual machine 2 can be built. Different application layer software is installed in the virtual machine 1 and the virtual machine 2. Packets can be generated and sent through the application layer software.

Multiple queues can be created in a memory of each virtual machine. Taking the virtual machine 2 as an example, the virtual machine 2 creates four queues, namely a queue 0 a queue 1, a queue 2 and a queue 3, which are used to temporarily store packets sent by the application layer software in the virtual machine. In addition, each virtual machine can have at least one virtual network interface card. As shown in FIG. 1, the virtual machine 1 has one virtual network interface card and the virtual machine 2 has two virtual network interface cards. Each virtual network interface card has a corresponding cache area for temporarily storing packets taken from queues.

The virtual switch includes multiple ports, which can be used to connect to the virtual network interface card or the physical network interface card to realize multi-layer data forwarding. As shown in FIG. 1, the packet sent by the virtual network interface card can be sent to the physical network interface card via the port of the virtual switch.

The physical network interface card may include multiple physical ports. As shown in FIG. 1, the physical network interface card may include three ports, namely a physical port 0, a physical port 1 and a physical port 2. The packet sent to the physical network interface card can be sent to the physical switch through a physical port in the physical network interface card, and then sent to the physical network through the physical switch. It should be understood that the number of physical ports of each physical network interface card can be identical or different.

It should be understood that the hypervisor is responsible for managing the virtual machine 1 and the virtual machine 2, and allocating system resources to the virtual machine 1 and the virtual machine 2.

A user can transmit a packet through the application layer software in the virtual machine. The packet sent by the application layer software is temporarily stored in the queues of the memory in the virtual machine, and the packet in the queues is waiting to be processed or sent. When transmitting the packet, the virtual network interface card can take a packet from the queue according to the FIFO principle, transmit the packet to the physical port of the physical network interface card through the port of the virtual switch, and transmit the packet through a physical port. In this way, the packet can be sent to the physical network via the physical switch.

It should be understood that the present application does not specifically limit the number of virtual machines, the number of virtual network interface cards, the number of ports of the virtual switch, the number of physical network interface cards, the number of physical ports, and the number of queues constructed, which can be set by those skilled in the art according to actual needs.

Currently; after taking a packet from the queue, the virtual network interface card puts the packet after being taken in the cache area and calculate a hash value based on the five-tuple carried by the packet to determine from which physical port of the physical network interface card the packet is to be sent. However, since the virtual network interface card blindly takes a packet from the queue and determines to which physical port the packet is sent only after taking the packet and calculating the hash value, if it is determined that the packet is sent to a heavy-loaded physical port (assuming that the number of packets queuing for being transmitted at the physical port 1 is already large, exceeding the carrying capacity of the physical port 1), this may cause traffic congestion and increase the delay of the heavy-loaded physical port. For light-loaded physical ports (assuming that the number of packets queuing for being transmitted at the physical port 0 and the physical port 2 is small, far from the carrying capacity of the physical port 0 and the physical port 2), the transmission rate is low and cannot reach the bandwidth limit. Therefore, the current packet transmitting approach cannot effectively achieve load balance of the physical ports. In addition, placing packets in the cache area will occupy the cache. Once the cache is fully occupied, it is impossible to continue to take packets from the queue to transmit. which reduces the packet transmitting efficiency.

In view of this, the present application provides a method for transmitting a packet. When a virtual network interface card needs to transmit a packet, the following can be performed: excluding a heavy-loaded physical port from the plurality of physical ports according to load conditions of the ports of the physical network interface card and the preset condition, determining the light-loaded physical port as the target port, and determining the target queue corresponding to the target port according to the mapping relationships between the plurality of physical ports and the plurality of queues, and taking the packet from the target queue and transmitting the packet through the target port. Since the light-loaded physical port is determined first, and there is a mapping relationship between the physical port and the queue, based on the determined light-loaded physical port, the virtual network interface card can take the packet from the corresponding queue for transmission. On the one hand, the traffic of the light-loaded physical port can be increased, and its transmission rate can be improved to reach the bandwidth limit. On the other hand, the transmission of packets through the heavy-loaded physical port can be temporarily postponed to avoid further aggravation of transmission delay and congestion. In summary, the bandwidth of each physical port can reach an upper limit, the transmission delay and congestion are alleviated, and the load balance between the physical ports is achieved. In addition, the packet taken from the queue does not need to pass through the cache area of the virtual network interface card, avoiding the occupation of the cache area.

The method for transmitting a packet provided in embodiments of the present application will be described in detail in conjunction with the accompanying drawings.

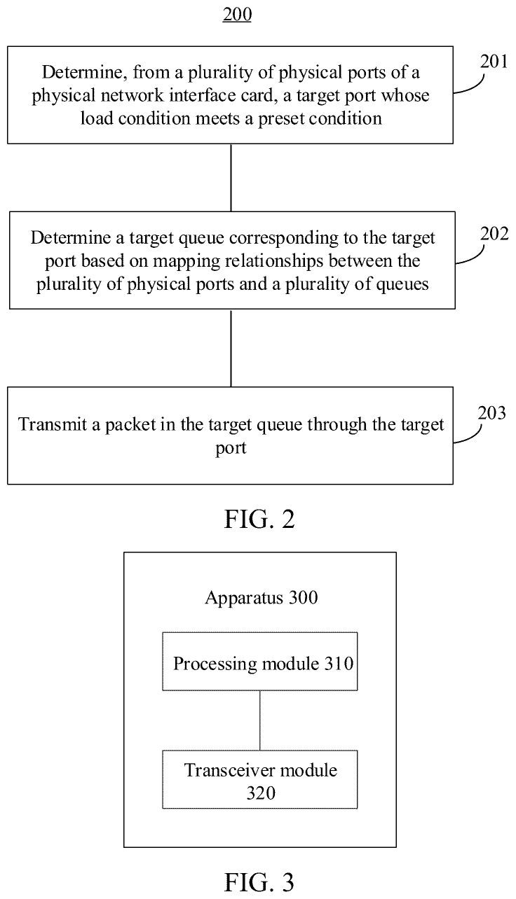

Refer to FIG. 2, which is a schematic flow chart of a method for transmitting a packet provided in an embodiment of the present application. It should be understood that a method 200 shown in FIG. 2 can be executed by a virtual network interface card, or by a physical device (such as a server, etc.) that can provide a function of a virtual network interface card, or by a component (such as a chip, a chip system, etc.) configured in the physical device, or by a module that can implement some or all of the functions of the virtual network interface card, etc.

When the method 200 is executed by a physical device, the physical device can be, for example, a server. For example, virtualization is performed on the basis of the physical network interface card of the server, and one or more virtual network interface cards can be obtained and exposed to the user. In addition, the physical device can implement the functions performed by the virtual network interface card in the following embodiments by executing a computer program, etc., to provide services to the user, so as to achieve load balance of the physical ports.

For the convenience of illustration, the method provided in the embodiment of the present application is described by taking a virtual network interface card as an example.

It should also be understood that the method 200 shown in FIG. 2 can be applied to a cloud server.

The method 200 may include steps 201 to 203. The steps in the method 200 shown in FIG. 2 are described in detail below.

Step 201, determine, from a plurality of physical ports of a physical network interface card, a target port whose load condition meets a preset condition.

The virtual network interface card can perform a statistic on load conditions of physical ports of the physical network interface card, and use the preset condition to first determine a light-loaded physical port as the target port, and the number of target port(s) can be one or more.

Two examples of the preset condition are given below.

In one example, the preset condition includes: a number of accumulated packets is less than a preset threshold. Correspondingly, the target port is a physical port where the number of accumulated packets is less than the preset threshold.

The preset threshold is a critical value for judging whether the physical port is a heavy-loaded port or a light-loaded port. Each physical port can correspond to a preset threshold, and the preset threshold of each physical port can be the same or different. It should be understood that those skilled in the art can set a specific value of the preset threshold according to actual needs, which is not limited in the present application.

The virtual network interface card can count the number of packets accumulated at each physical port of the physical network interface card, and determine whether the physical port is heavy-loaded or light-loaded in combination with the preset threshold of each physical port. When the number of packets accumulated at a physical port is greater than or equal to the preset threshold, the physical port is a heavy-loaded port; and when the number of packets accumulated at a physical port is less than the preset threshold, the physical port is a light-loaded port. The physical ports where the number of packets accumulated at the port is less than the preset threshold are filtered out, that is, the light-loaded ports are used as target ports.

For example, it is assumed that the preset threshold of the physical port 0 is 100 packets, the preset threshold of the physical port 1 is 250 packets, and the preset threshold of the physical port 2 is 250 packets. The virtual network interface card counts the number of packets accumulated at the three physical ports and finds that the number of packets accumulated at the physical port 0 is 80, the number of packets accumulated at the physical port 1 is 300, and the number of packets accumulated at the physical port 2 is 200. Therefore, the physical port 0 and the physical port 2 can be used as target physical ports.

In another example, the preset condition includes: a rate at which packets enter a physical port is higher than a rate at which packets are sent from the physical port per unit time. Accordingly, the target port is a physical port at which the rate at which packets enter the physical port is higher than the rate at which packets are sent from the physical port per unit time.

The virtual network interface card can determine whether the physical port is heavy-loaded or light-loaded by the relationship between the rate at which packets enter the physical port and the rate at which packets are sent from the physical port. When the rate at which packets enter the physical port is lower than the rate at which packets are sent from the physical port, it indicates that port delay has occurred and the port is a heavy-loaded port; and when the rate at which packets enter the physical port is higher than the rate at which packets are sent from the physical port, it indicates that port delay does not occur and the port is a light-loaded port, and such ports can be used as target ports. It should be understood that when the rate at which packets enter the physical port is equal to the rate at which packets are sent from the physical port, it indicates that the physical port is in a critical state between heavy load and light load and thus is not used as a target port.

For example, within 1 second, the rate at which packets enter the physical port 0 is 1,500 bits per second (BPS), and the rate at which packets are sent from the physical port 0 is 1,000 bps; the rate at which packets enter the physical port 1 is 2,000 bps, and the rate at which packets are sent from the physical port 1 is 2,200 bps; and the rate at which the packets enter the physical port 2 is 1,700 bps, and the rate at which packets are sent from the physical port 2 is 900 bps. Therefore, the physical port 0 and the physical port 2 can be used as target physical ports. It should be understood that the bit rate refers to the number of bits transmitted per unit time.

The number of target ports determined by the virtual network interface card can be one or more.

It should be understood that when any physical port of the physical network interface card does not meet the preset condition, there is no target port. In this case, it temporarily does not take any packet from the queues for transmission.

Step 202, determine a target queue corresponding to the target port based on mapping relationships between the plurality of physical ports and a plurality of queues.

One or more queues of the plurality of queues correspond to one physical port of the plurality of physical ports, and the plurality of queues are used to cache to-be-transmitted packets. That is, each physical port can correspond to one or more queues.

The mapping relationship between the physical port and the queue can be specifically a mapping relationship between a physical port number and a queue identifier (ID).

Two ways of representing the mapping relationship are given as examples below.

In one example, when the queue IDs of the virtual machines are different, for example, the queue IDs in the virtual machine 2 are: a queue 0, a queue 1, a queue 2 and a queue 3, and the queue IDs in the virtual machine 1 are: a queue 4, a queue 5, a queue 6 and a queue 7, therefore, a mapping relationship between the queue ID and the physical port number can be established.

In another example, when the queue IDs in different virtual machines are the same, for example, the queue IDs in one virtual machine are: a queue 0, a queue 1, a queue 2 and a queue 3, and the queue IDs in another virtual machine are still: a queue 0, a queue 1, a queue 2 and a queue 3, then, different IDs can be set for different virtual machines, for example, the ID of one virtual machine is set to the virtual machine 1, and the ID of another virtual machine is set to the virtual machine 2. Then the identity of the queue can be identified by the virtual machine ID and the queue ID. Therefore, a mapping relationship between the virtual machine ID plus the queue ID and the physical port number can be established.

The virtual network interface card can determine the target queue corresponding to the target port based on the established mapping relationship. For example, for the virtual machine 2, the established mapping relationship is: the physical port 0 corresponds to the queue 0 and the queue 3, the physical port 1 corresponds to the queue 1, and the physical port 2 corresponds to the queue 2. Assuming that the target ports determined by the virtual network interface card are the physical port 0 and the physical port 2, the target queues corresponding to the physical port 0 are the queue 0 and the queue 3, and the target queue corresponding to the physical port 2 is the queue 2.

As mentioned above, the number of target port(s) can be one or more. Based on the above mapping relationship, the number of target queues corresponding to the target port can also be one or more.

In an implementation, the method further includes: obtaining the mapping relationships between the plurality of physical ports and the plurality of queues.

The virtual network interface card can obtain the mapping relationship in the following two ways.

One possible implementation is that the virtual network interface card obtains a pre-configured mapping relationship.

For example, during creating a virtual network interface card, the mapping relationships between the plurality of queues and the plurality of physical ports can be configured according to the queues in the virtual machine and the physical ports in the physical network interface card, and saved locally. When the virtual network interface card needs to use the mapping relationship, the above mapping relationship can be obtained locally. This approach allows the virtual network interface card to quickly determine the target queue of the target port and increases the packet transmitting speed.

In a specific implementation, the virtual network interface card can establish the mapping relationship by dividing the queue ID by the number of physical ports and taking the remainder.

The queues and the physical ports in the virtual machine 2 shown in FIG. 1 are taken as an example. For determining the physical port corresponding to the queue 0, the queue ID 0 is divided by 3 which is the number of physical ports, and the remainder is 0, then the physical port corresponding to the queue 0 is the physical port 0; for determining the physical port corresponding to the queue 1, the queue ID 1 is divided by 3 which is the number of physical ports, and the remainder is 1, then the physical port corresponding to the queue 1 is the physical port 1; for determining the physical port corresponding to the queue 2, the queue ID 2 is divided by 3 which is the number of physical ports, and the remainder is 2, then the physical port corresponding to the queue 2 is the physical port 2; and for determining the physical port corresponding to the queue 3, the queue ID 3 is divided by 3 which is the number of physical ports, and the remainder is 0, then the physical port corresponding to the queue 3 is the physical port 0. Therefore, the mapping relationship between the queues and the physical ports can be obtained.

It should be understood that a queue that can participate in establishing the mapping relationship is a queue that temporarily stores packets, and an empty queue that does not temporarily store packets in the queue cannot participate in the establishment of the mapping relationship. For example, when the queue 3 is an empty queue, only the mapping relationship between the queue 0 to the queue 2 and the physical port 0 to the physical port 2 can be established, and the mapping relationship between the queue 3 and the physical port is not established.

Another possible implementation is that the virtual network interface card temporarily establishes the mapping relationship.

When transmitting a packet, the virtual network interface card can also temporarily establish the mapping relationship based on the queues that currently have packets to be sent and the physical ports in the physical network interface card. The mapping relationship established in this way is more in line with a current actual situation and can more effectively achieve load balance of physical ports.

Since the number of packets in each queue changes in real time, and the load situation of each physical port also changes, the above mapping relationship can be adjusted.

In an implementation, the method further includes: adjusting the mapping relationships between the plurality of physical ports and the plurality of queues according to a number of packets in each of the plurality of queues.

One possible situation is to add a mapping relationship. After the mapping relationship has been established, if the virtual network interface card finds that there is a new queue in the memory of the virtual machine, a statistic on the load situation at each physical port of the physical network interface card can be made, a physical port with a smallest load can be determined, and a mapping relationship between the new queue and this physical port can be established to adjust the mapping relationship. Alternatively, the virtual network interface card can still establish a mapping relationship between the new queue and the physical port by dividing the queue ID by the number of physical ports and taking the remainder.

It should be understood that the new queue is a newly added queue that needs to transmit packets, and the new queue temporarily stores packets. That is, the new queue can be a newly added queue. For example, on the basis of the existing the queues 0 to 4, a queue 5 is additionally created, and there are packets temporarily stored in the queue 5, then the queue 5 is a new queue. Alternatively, the new queue can be an existing queue that was previously an empty queue. For example, the queue 3 was previously an empty queue, and no mapping relationship with the physical port was established. However, at a certain moment, packets that need to be sent are temporarily stored in the queue 3, then the virtual network interface card can use the queue 3 as a new queue to establish a mapping relationship with the physical port.

Another possible situation is to release a mapping relationship. After the mapping relationship has been established, if the virtual network interface card finds that a queue is constantly an empty queue within a preset time, the mapping relationship between the queue and the corresponding physical port can be released.

Another possible situation is to change a mapping relationship between a queue and a physical port. After establishing a mapping relationship between a light-loaded physical port and a queue, the virtual network interface card transmits the packets in the queue corresponding to the light-loaded physical port to the light-loaded physical port one by one. If after a period of time, the number of packets accumulated at the light-loaded physical port increases and the light-loaded physical port becomes a heavy-loaded physical port, light-loaded physical ports are re-determined from the plurality of physical ports, and the mapping relationship is established between the queues and the re-determined physical ports. For example, when the light-loaded physical port 1 corresponds to the queue 1, the virtual network interface card transmits the packets of the queue 1 to the physical port 1. As the number of packets accumulated at physical port 1 gradually increases, when the physical port 1 becomes a heavy-loaded physical port, the virtual network interface card re-determines the physical port 2 as a light-loaded physical port, and a mapping relationship is established between the queue 1 and the physical port 2.

Step 203, transmit a packet in the target queue through the target port.

After determining the target queue corresponding to the target port, the virtual network interface card can take the packet from the target queue, transmit the packet to the corresponding target port, and transmit the packet to the physical network through the target port.

As mentioned above, the number of target ports can be one or more, and the number of target queues can also be one or more. The specific process of step 203 may be different for different situations.

When the number of target port(s) is one, the virtual network interface card can directly take the packet in the target queue and transmit the packet to the target port so as to transmit the packet to the physical network through the target port.

In one example, the number of target queue(s) corresponding to the target port is one. Assuming that the target port is the physical port 2, and it is determined that physical port 2 corresponds to the queue 2, the virtual network interface card takes the packet from the queue 2 and transmits the packet to the physical port 2, and transmits the packet to the physical network through the physical port 2.

In another example, the number of target queues corresponding to the target port is more than one. Assuming that the target port is the physical port 0, and it is determined that the physical port 0 corresponds to the queue 0 and the queue 3, the virtual network interface card can first transmit the packets in the queue 0 to the physical port 0, and after the packets in the queue 0 are all sent, transmit the packets in the queue 3 to the physical port 0; the virtual network interface card can also first transmit the packets in the queue 3 to the physical port 0, and then transmit the packets in the queue 0 to the physical port 0 after the packets in the queue 3 are all sent; and the virtual network interface card can also transmit the packets in the queue 0 and the queue 3 to the physical port 0 alternately.

When there are multiple target ports, the virtual network interface card can sort them according to the load conditions of the target ports, to first transmit the packets to a target port with a lighter load, and then transmit the packets to a target port with a relatively heavy load. Specifically, when there are multiple target ports determined by the virtual network interface card, the target ports can be sorted according to the number of packets accumulated at the ports, or the target ports can be sorted according to a ratio or a difference between the rate at which packets enter the port and the rate at which packets are sent from the port, to obtain the sorted target ports, and then the packets are sent according to the sorting order. It should be understood that the physical ports determined as target ports are all physical ports, but with various light-loaded degrees.

Alternatively, the load conditions of the target ports can be ignored, and for taking a packet each time, the packet can be randomly taken from multiple target queues and sent to the corresponding target port.

The following is an example explanation where the load conditions of the target ports are taken into consideration.

In an example, it is assumed that the target ports are the physical port 0 and the physical port 2, the target queues of the physical port 0 are the queue 0 and the queue 3, and the target queue of the physical port 2 is the queue 2. The number of packets accumulated at the physical port 0 is 80, and the number of packets accumulated at the physical port 2 is 200.

When the preset thresholds of the respective physical ports are the same, sorting can be performed directly according to the number of accumulated packets. It is thus determined that the number of packets accumulated at the physical port 0 is less than the number of packets accumulated at the physical port 2, which means that the load of the physical port 0 is smaller than that of the physical port 2. Then, packets are preferentially taken from the queue 0 and the queue 3 and then sent to the physical port 0, and then packets are taken from the queue 2 and sent to the physical port 2.

When the preset thresholds of the respective physical ports are different. sorting can be performed according to the degree of packet accumulation at the physical port. The degree of packet accumulation can be reflected by the ratio of the number of packets accumulated at the physical port to the preset threshold, or an absolute value of the difference between the number of packets accumulated at the physical port and the preset threshold. The larger the ratio or the smaller the absolute value of the difference, the more serious the packet accumulation. For example, a preset threshold of the physical port 2 is 250 packets, and a preset threshold of the physical port 0 is 100 packets. The accumulation degree of packets at the physical port 2 is lower than that at the physical port 0, which means that the load of the physical port 2 is smaller than that of the physical port 0. In this case, packets are preferentially taken from the queue 2 and then sent to the physical port 2, and then packets are taken from the queue 0 and the queue 3 and sent to the physical port 0.

In another example, it is assumed that the target ports are the physical port 0 and the physical port 2, the target queues of the physical port 0 are the queue 0 and the queue 3, and the target queue of the physical port 2 is the queue 2. The rate at which packets enter the physical port 0 is 1,500 bps, the rate at which packets are sent from the physical port 0 is 1,000 bps, and the rate difference of the physical port 0 is 500 bps; and the rate at which packets enter the physical port 2 is 1,700 bps, the rate at which packets are sent from the physical port 2 is 900 bps, and the rate difference of the physical port 2 is 800 bps. The rate difference of the physical port 2 is greater than the rate difference of the physical port 0, indicating that the load of the physical port 2 is smaller than that of the physical port 0. In this case, packets are preferentially taken from the queue 2 and sent to the physical port 2, and then packets are taken from the queue 0 and the queue 3 and sent to the physical port 0.

It should be understood that reference for the order of taking packets from the queue 0 and the queue 3 for transmission can be made to the previous description of the case where the number of target queues corresponding to the target port is more than one, and no further description is repeated.

In summary, it can be seen that the mapping relationships between the plurality of physical ports and the plurality of queues proposed in the present application are different from the mapping relationship between the five-tuple hash value of the packets and the physical port. Since in the current technology, the virtual network interface card blindly takes a packet from the queues, and only after the packet is taken, it can calculate the five-tuple hash value to determine the corresponding physical port. Therefore, the possibility of transmitting packets to heavy-loaded physical ports cannot be avoided.

In the present application, the mapping relationship is established between the physical ports and the queues, and after the heavy-loaded physical port is excluded from the plurality of physical ports according to the preset condition and the light-loaded physical port is determined as the target port, the target queue corresponding to the target port is determined according to the mapping relationships between the plurality of physical ports and the plurality of queues, and the packet is taken from the target queue and sent through the target port. Since the light-loaded physical port is determined first, and there is the mapping relationship between the physical port and the queue, the virtual network interface card can take, based on the determined light-loaded physical port, the packet from the corresponding queue for transmission. On the one hand, the traffic of the light-loaded physical port can be increased, and its transmission rate can be improved to reach the bandwidth limit. On the other hand, the transmission of packets through the heavy-loaded physical port can be temporarily postponed to avoid further aggravation of transmission delay and congestion. In summary; the bandwidth of each physical port can reach an upper limit, the transmission delay and congestion are alleviated, and the load balance between the physical ports is achieved. In addition, the packet taken from the queue can be sent directly to the corresponding physical port for transmission, without introducing an additional cache area to store the packet, avoiding the occupation of storage space.

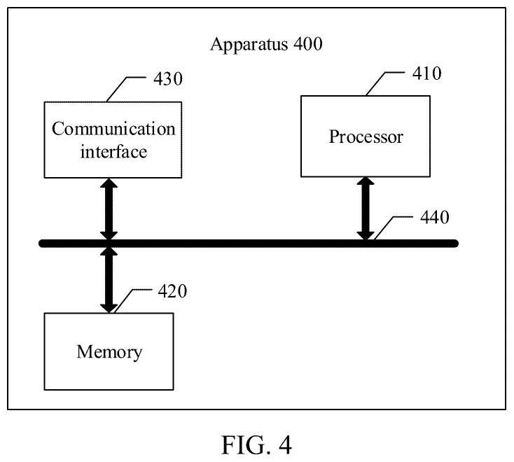

The method provided by the embodiments of the present application is described above in detail in conjunction with FIG. 2. The following is a detailed description of an apparatus provided by embodiments of the present application in conjunction with FIGS. 3 and 4.

FIG. 3 is a schematic block diagram of an apparatus provided by an embodiment of the present application. As shown in FIG. 3, the apparatus 300 may include: a processing module 310 and a transceiver module 320. Each unit in the apparatus 300 may be configured to implement the corresponding functions of the virtual network interface card in the method 200 shown in FIG. 2. For example, the processing module 310 may be configured to execute step 201 and step 202 in the method 200, and the transceiver module 320 may be configured to execute step 203 in the method 200.

Specifically, the processing module 310 may be configured to determine, from a plurality of physical ports of a physical network interface card, a target port whose load condition meets a preset condition and determine a target queue corresponding to the target port based on mapping relationships between the plurality of physical ports and a plurality of queues, where one or more queues of the plurality of queues correspond to one physical port of the plurality of physical ports, and the plurality of queues are used to cache to-be-transmitted packets; and the transceiver module 320 may be configured to transmit a packet in the target queue through the target port.

In an implementation, the preset condition includes: a number of accumulated packets is less than a preset threshold.

In an implementation, the preset condition includes: a rate at which packets enter a physical port is higher than a rate at which packets are sent from the physical port per unit time.

In an implementation, the processing module 310 can further be configured to obtain the mapping relationships between the plurality of physical ports and the plurality of queues.

In an implementation, the processing module 310 can further be configured to adjust the mapping relationships between the plurality of physical ports and the plurality of queues according to a number of packets in each of the plurality of queues.

It should be understood that the division of modules in the embodiments of the present application is for a schematic purpose and is only a logical function division. There may be other division methods in actual implementation. In addition, each functional module in each embodiment of the present application can be integrated into a processor, or can exist physically separately, or two or more modules can be integrated into one module. The above-mentioned integrated module can be implemented in the form of hardware or in the form of software functional modules.

FIG. 4 is another schematic block diagram of an apparatus provided in an embodiment of the present application. The apparatus 400 can be configured to implement the function of the virtual network interface card in the above method 200. The apparatus 400 can be a chip system. In embodiment of the present application, the chip system can be composed of a chip, or can include a chip and other discrete devices.

As shown in FIG. 4, the apparatus 400 may include at least one processor 410 for implementing the functions of the virtual network interface card in the method 200 provided in the embodiments of the present application.

For example, when the apparatus 400 is configured to implement the functions of the virtual network interface card in the method 200 provided in the embodiments of the present application, the processor 410 may be configured to: determine, from a plurality of physical ports of a physical network interface card, a target port whose load condition meets a preset condition; determine a target queue corresponding to the target port based on mapping relationships between the plurality of physical ports and a plurality of queues, where one or more queues of the plurality of queues correspond to one physical port of the plurality of physical ports, and the plurality of queues are used to cache to-be-transmitted packets; and transmit a packet in the target queue through the target port. For details, please refer to the detailed description in the method examples, which will not be repeated here.

The apparatus 400 may also include at least one memory 420 for storing program instructions and/or data. The memory 420 is coupled to the processor 410. The coupling in embodiments of the present application is an indirect coupling or communication connection between apparatuses, units or modules, which may be electrical, mechanical or in other forms, and is used for information exchange between apparatuses, units or modules. The processor 410 may operate in coordination with the memory 420. The processor 410 may execute program instructions stored in the memory 420. At least one of the at least one memory may be included in the processor.

The apparatus 400 may further include a communication interface 430 for communicating with other devices through a transmission medium, so that the apparatus 400 can communicate with other devices. For example, when the apparatus 400 is configured to implement the functions of the virtual network interface card in the method 200 provided in the embodiments of the present application, the other devices may be a physical network interface card; the communication interface 430 may be, for example, a transceiver, an interface, a bus, a circuit, or an apparatus capable of implementing the transceiver function. The processor 410 may use the communication interface 430 to transmit and receive data and/or information, to implement the method executed by the virtual network interface card in the embodiments corresponding to FIG. 2.

The specific connection medium between the above-mentioned processor 410, the memory 420 and the communication interface 430 is not limited in embodiments of the present application. In FIG. 4, in the embodiment of the present application, the processor 410, the memory 420 and the communication interface 430 are connected by a bus. The bus is represented by a thick line in FIG. 4, and the connection method between other components is only for schematic illustration and is not limited to this. The bus can be divided into an address bus, a data bus, a control bus, etc. For ease of representation, only one thick line is used in FIG. 4, but it does not mean that there is only one bus or one type of bus.

It should be understood that the processor in the embodiments of the present application can be an integrated circuit chip with signal processing capabilities. In the implementation process, each step of the above method embodiments can be completed by the hardware integrated logic circuit in the processor or the instructions in the form of software. The above processor can be a general processor, a digital signal processor (DSP), an application specific integrated circuit (ASIC), a field programmable gate array (FPGA) or other programmable logic devices, discrete gates or transistor logic devices, discrete hardware components, which can implement or execute the methods, the steps and the logic block diagrams disclosed in the embodiments of the present application. The general processor can be a microprocessor or the processor can also be any conventional processor, etc. The steps of the method disclosed in the embodiments of the present application can be directly embodied as being performed by a hardware decoding processor, or being performed by a combination of hardware and software modules in the decoding processor. The software module may be located in a mature storage medium in the art such as a random access memory, a flash memory, a read-only memory, a programmable read-only memory, or an electrically erasable programmable memory, a register, etc. The storage medium is located in the memory, and the processor reads the information in the memory and completes the steps of the above method in combination with its hardware.

It should also be understood that the memory in the embodiments of the present application may be a volatile memory or a non-volatile memory, or may include both volatile and non-volatile memories. The non-volatile memory may be a read-only memory (ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (RAM), which is used as an external cache. By way of example but not limitation, many forms of RAMs are available, such as a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchronous link dynamic random access memory (synchlink DRAM, SLDRAM), and a direct rambus random access memory (direct rambus RAM, DR RAM). It should be noted that the memories of the system and method described herein are intended to include but not limited to these and any other suitable types of memories.

The present application also provides a chip system. The chip system includes at least one processor for implementing the functions involved in the virtual network interface card in the embodiments shown in FIG. 2 above.

In one possible design, the chip system further includes a memory, the memory is used to store program instructions and data, and the memory is located within or outside the processor.

The chip system can be composed of a chip, or can include a chip and other discrete devices.

As mentioned above, the above method can be implemented by executing a computer program, or by a logic circuit, an integrated circuit, etc. solidified on a chip. Therefore, the present application also provides a chip, which includes a logic circuit or an integrated circuit. The mapping relationships between the plurality of physical ports and the plurality of queues described in the above method embodiments, as well as each preset threshold, can be implemented by an external configured method, which is not limited by the present application.

The present application also provides an electronic device, which includes: a processor, a memory, and a computer program stored in the memory and executable in the processor, and when the computer program is executed by the processor, the method of the embodiment shown in FIG. 2 is implemented.

The present application also provides a computer-readable storage medium, which stores a computer program (also referred to as codes or instructions). When the computer program is running, a computer is enabled to execute the method of the embodiment shown in FIG. 2.

The terms “unit”, “module”, etc. used in this specification can be used to represent computer-related entities, hardware, firmware, a combination of hardware and software, software, or software in execution.

A person of ordinary skill in the art can realize that the various illustrative logical blocks and steps described in conjunction with the embodiments disclosed herein can be implemented in electronic hardware, or a combination of computer software and electronic hardware. Whether these functions are implemented in hardware or software depends on the specific application and design constraints of the technical solution. Professional technicians can use different methods to implement the described functions for each specific application. However, such implementation should not be considered beyond the scope of the present application. In the several embodiments provided in the present application, it should be understood that the disclosed apparatuses, devices and methods can be implemented in other ways. For example, the apparatus embodiments described above are only for schematic purposes. For example, the division of the unit is only a logical function division. There may be other division methods in actual implementation, for example, multiple units or components can be combined or integrated into another system, or some features can be ignored or not executed. Another point is that the mutual coupling or direct coupling or communication connection shown or discussed can be indirect coupling or communication connection of apparatuses or units through some interfaces, which can be electrical, mechanical or in other forms.

The units described as separate components may or may not be physically separated, and the components displayed as units may or may not be physical units, that is, they may be located in one place, or be distributed in multiple network units. Some or all of the units can be selected according to actual requirements to achieve the purpose of the present embodiment.

In addition, functional units in embodiments of the present application can be integrated into a processing unit, or can exist physically separately, or two or more units can be integrated into one unit.

In the above embodiments, the functions of each functional unit can be implemented in whole or in part by software, hardware, firmware or any combination thereof. When implemented using software, the functions can be implemented in whole or in part in the form of a computer program product. The computer program product includes one or more computer instructions (programs). When the computer program instructions (programs) are loaded and executed in a computer, the process or function according to the embodiments of the present application is generated in whole or in part. The computer can be a general-purpose computer, a special-purpose computer, a computer network, or other programmable devices. The computer instructions may be stored in a computer-readable storage medium, or transmitted from one computer-readable storage medium to another computer-readable storage medium. For example, the computer instructions may be transmitted from one website, computer, server, or data center to another website, computer, server, or data center via a wired (e.g., a coaxial cable, an optical fiber, a digital subscriber line (digital subscriber line, DSL)) or wireless (e.g., infrared, wireless, microwave, etc.) method. The computer-readable storage medium may be any available medium that can be accessed by a computer or a data storage device such as a server or data center that includes one or more available media integrated therein. The available medium may be a magnetic medium (e.g., a floppy disk, a hard disk, a magnetic tape), an optical medium (e.g., a digital video disc (DVD)), or a semiconductor medium (e.g., a solid state disk (SSD)) and so on.

If this function is implemented in the form of a software functional unit and sold or used as an independent product, it can be stored in a computer-readable storage medium. Based on this understanding, the technical solution of the present application essentially or the part of this technical solution that contributes to the prior art or the part of the technical solution can be embodied in the form of a software product. The computer software product is stored in a storage medium, including several instructions to enable a computer device (which can be a personal computer, a server, or a network device, etc.) to perform all or part of the steps of the various embodiments of the present application. The aforementioned storage medium includes: a U disk, a mobile hard disk, a ROM, a RAM, a disk or an optical disk and other media that can store program codes.

The above are only specific implementations of the present application, but the protection scope of the present application is not limited to this. Any skilled person familiar with the technical field can easily think of changes or replacements within the technical scope disclosed in the present application, which should be covered within the protection scope of the present application. Therefore, the protection scope of the present application shall be subject to the protection scope of the claims.

1. A method for transmitting a packet, comprising:
determining, from a plurality of physical ports of a physical network interface card, a target port whose load condition meets a preset condition;
determining a target queue corresponding to the target port based on mapping relationships between the plurality of physical ports and a plurality of queues, wherein one or more queues of the plurality of queues correspond to one physical port of the plurality of physical ports, and the plurality of queues are used to cache to-be-transmitted packets;
transmitting a packet in the target queue through the target port.

2. The method according to claim 1, wherein the preset condition comprises: a number of accumulated packets is less than a preset threshold.

3. The method according to claim 1, wherein the preset condition comprises: a rate at which packets enter a physical port is higher than a rate at which packets are sent from the physical port per unit time.

4. The method according to claim 1, wherein before determining the target queue corresponding to the target port based on the mapping relationships between the plurality of physical ports and the plurality of queues, the method further comprises:
obtaining the mapping relationships between the plurality of physical ports and the plurality of queues.

5. The method according to claim 4, wherein the method further comprises:
adjusting the mapping relationships between the plurality of physical ports and the plurality of queues according to a number of packets in each of the plurality of queues.

6. An apparatus for transmitting a packet, comprising:
a processor,
a memory,
a communication interface connected with the processor; and
a computer program stored in the memory and executable in the processor, wherein the computer program, when executed by the processor, causes the processor:
determine, from a plurality of physical ports of a physical network interface card, a target port whose load condition meets a preset condition and determine a target queue corresponding to the target port based on mapping relationships between the plurality of physical ports and a plurality of queues, wherein one or more queues of the plurality of queues correspond to one physical port of the plurality of physical ports, and the plurality of queues are used to cache to-be-transmitted packets;
transmit, through the communication interface, a packet in the target queue through the target port.

7. The apparatus according to claim 6, wherein before determining the target queue corresponding to the target port based on the mapping relationships between the plurality of physical ports and the plurality of queues, the processor is further caused to obtain the mapping relationships between the plurality of physical ports and the plurality of queues.

8. The apparatus according to claim 7, wherein the processor is further caused to adjust the mapping relationships between the plurality of physical ports and the plurality of queues according to a number of packets in each of the plurality of queues.

9. (canceled)

10. A non-transitory computer-readable storage medium, wherein the computer-readable storage medium stores a computer program which, when executed by a processor, causes the processor to implement the following:
determining, from a plurality of physical ports of a physical network interface card, a target port whose load condition meets a preset condition;
determining a target queue corresponding to the target port based on mapping relationships between the plurality of physical ports and a plurality of queues, wherein one or more queues of the plurality of queues correspond to one physical port of the plurality of physical ports, and the plurality of queues are used to cache to-be-transmitted packets;
transmitting, through a communication interface, a packet in the target queue through the target port.

11. The method according to claim 2, wherein before determining the target queue corresponding to the target port based on the mapping relationships between the plurality of physical ports and the plurality of queues, the method further comprises:
obtaining the mapping relationships between the plurality of physical ports and the plurality of queues.

12. The method according to claim 3, wherein before determining the target queue corresponding to the target port based on the mapping relationships between the plurality of physical ports and the plurality of queues, the method further comprises:
obtaining the mapping relationships between the plurality of physical ports and the plurality of queues.

13. The apparatus according to claim 6, wherein the preset condition comprises: a number of accumulated packets is less than a preset threshold.

14. The apparatus according to claim 6, wherein the preset condition comprises: a rate at which packets enter a physical port is higher than a rate at which packets are sent from the physical port per unit time.

15. The apparatus according to claim 13, wherein before determining the target queue corresponding to the target port based on the mapping relationships between the plurality of physical ports and the plurality of queues, the processor is further caused to obtain the mapping relationships between the plurality of physical ports and the plurality of queues.

16. The apparatus according to claim 14, wherein before determining the target queue corresponding to the target port based on the mapping relationships between the plurality of physical ports and the plurality of queues, the processor is further caused to obtain the mapping relationships between the plurality of physical ports and the plurality of queues.

17. The storage medium according claim 10, wherein the preset condition comprises: a number of accumulated packets is less than a preset threshold.

18. The storage medium according claim 10, wherein the preset condition comprises: a rate at which packets enter a physical port is higher than a rate at which packets are sent from the physical port per unit time.

19. The storage medium according claim 10, wherein before determining the target queue corresponding to the target port based on the mapping relationships between the plurality of physical ports and the plurality of queues, the processor is further caused to implement the following:
obtaining the mapping relationships between the plurality of physical ports and the plurality of queue.

20. The storage medium according claim 17, wherein before determining the target queue corresponding to the target port based on the mapping relationships between the plurality of physical ports and the plurality of queues, the processor is further caused to implement the following:
obtaining the mapping relationships between the plurality of physical ports and the plurality of queue.

21. The storage medium according claim 19, wherein the processor is further caused to implement the following:
adjusting the mapping relationships between the plurality of physical ports and the plurality of queues according to a number of packets in each of the plurality of queues.
